(19) United States
(12) Patent Application Publication
(10) Pub. No.: US 2021/0305570 A1
(43) Pub. Date: Sep. 30, 2021

(54) METHOD OF MANUFACTURING NITROGEN-CARBON AGGREGATE HAVING HIERARCHICAL PORE STRUCTURE, NITROGEN-CARBON AGGREGATE MANUFACTURED THEREFROM, AND SODIUM ION BATTERY INCLUDING SAME

(71) Applicant: KOREA MARITIME UNIVERSITY INDUSTRY-ACADEMIC COOPERATION FOUNDATION, Busan (KR)

(72) Inventors: Jun Kang, Busan (KR); Dae Young Kim, Busan (KR)

(73) Assignee: KOREA MARITIME UNIVERSITY INDUSTRY-ACADEMIC COOPERATION FOUNDATION

(21) Appl. No.: 16/893,693

(22) Filed: Jun. 5, 2020

(30) Foreign Application Priority Data
Mar. 31, 2020 (KR) 10-2020-0039084

(51) Int. Cl. H01M 4/587; H01M 10/054; H01M 4/36

(52) U.S. Cl. CPC H01M 4/587; H01M 2004/021; H01M 4/364; H01M 10/054

(57) ABSTRACT

The present invention relates to a method of manufacturing a nitrogen-carbon aggregate having a hierarchical pore structure, a nitrogen-carbon aggregate manufactured therefrom, and a sodium ion battery including the same. The technical gist of the present invention includes a method of manufacturing a nitrogen-carbon aggregate having a hierarchical pore structure, a nitrogen-carbon aggregate manufactured therefrom, and a sodium ion battery including the same. The method includes a first step of manufacturing a precursor solution including a nitrogen-containing carbon precursor, a second step of disposing a pair of metal wires in the precursor solution, and a third step of applying electric power to the metal wires to discharge a plasma, so that nitrogen is bonded to carbon of the carbon precursor, thus forming nitrogen-doped carbon nanoparticles of a turbostratic structure including micropores in the surface thereof and then forming an aggregate having a meso-macro hierarchical pore structure due to agglomeration of the carbon nanoparticles. The number of active sites in the aggregate is increased due to nitrogen doping.

### REFERENCE TO RELATED APPLICATIONS

This application claims the priority benefit of Korean Patent Application No. 10-2020-0039084 filed on Mar. 31, 2020, the entire contents of which are incorporated herein by reference.

### FIELD OF THE INVENTION

The present invention relates to a method of manufacturing a nitrogen-carbon aggregate having a hierarchical pore structure, a nitrogen-carbon aggregate manufactured therefrom, and a sodium ion battery including the same.

### BACKGROUND OF THE INVENTION

Recently, as the demand for eco-friendly vehicles has increased, the electric vehicle market has been increasingly growing. Lithium ion batteries are most frequently used as energy storage media for electric vehicles, but the lithium available on earth is limited to very few countries in terms of storage amounts. Accordingly, it is difficult to maintain appropriate supply and demand for lithium ion batteries. For this reason, there has not been a quick respond to the growing demand for the electric vehicle market. Further, the International Maritime Organization has already announced strong greenhouse gas regulations to take effect in 2030. In order to attain the greenhouse gas regulation target values, electrically propelled ships as well as electric vehicles are essentially required.

Accordingly, demand for lithium ion batteries is expected to be great. However, when the demand for lithium ion batteries is rapidly increased, it is not easy to maintain a stable price of the lithium ion battery. Further, in the past, the demand for mobile devices required only high reversible capacity characteristics, but the current demand for electric vehicles and electrically propelled ships requires performance suited for the high discharge speed due to the characteristics thereof.

Therefore, various kinds of batteries able to replace lithium ion batteries have been studied. Among them, a sodium ion battery is attracting much attention as one of the next-generation rechargeable batteries that can replace the lithium ion battery due to the abundant amount of sodium precursors present in the earth's crust and seawater.

Since the sodium ion battery has an advantage of operating based on an electrochemical reaction similar to that of the lithium ion battery, graphite has been applied first as a cathode active material. However, sodium ions applied to sodium ion batteries are thermodynamically unstable in the presence of graphite, which interrupts the formation of a sodium-graphite intercalation compound (Na-GIC). Accordingly, the reversible capacity thereof is only 1/10 of that of the lithium ion battery. For this reason, hard carbon, having a number of nanopores and nanovoids has been studied as an alternative material for graphite. However, the reversible capacity of the hard carbon still shows performance that is lower than the performance required for practical use. Further, since hard carbon mostly has an initial coulombic efficiency (ICE) that stays below 50%, it is difficult to achieve commercialization thereof.

As a related art, ‘sodium ion secondary battery (Korean Patent No. 10-1635850)’ discloses the use of hard carbon as a cathode active material. However, in the case of the above patent, due to the graphene sheet structure randomly arranged in the hard carbon, sodium has slow kinetics, and thus there is a problem in that a high discharge capacity (rate-capability) is not satisfied.

Therefore, there is urgent need for research and development of new technologies for manufacturing a cathode active material that satisfies both excellent discharge capacity and high initial coulombic efficiency and has a stable life so as to be applicable to a sodium ion battery.
Korean Patent No. 10-1635850, registered on Jun. 28, 2016.

### SUMMARY OF THE INVENTION

Accordingly, the present invention has been made keeping in mind the above problems occurring in the related art, and an object of the present invention is to provide a method of manufacturing a nitrogen-carbon aggregate having a hierarchical pore structure so as to increase the number of active sites where sodium ions are adsorbed and then stored using nitrogen doping.

Another object of the present invention is to provide a nitrogen-carbon aggregate manufactured using the above method.

Yet another object of the present invention is to provide a sodium ion battery including the nitrogen-carbon aggregate.

In order to accomplish the above object, the present invention provides a method of manufacturing a nitrogen-carbon aggregate having a hierarchical pore structure. The method includes a first step of manufacturing a precursor solution including a nitrogen-containing carbon precursor, a second step of disposing a pair of metal wires in the precursor solution, and a third step of applying electric power to the metal wires to discharge a plasma, so that nitrogen is bonded to carbon of the carbon precursor, thus forming nitrogen-doped carbon nanoparticles of a turbostratic structure including micropores in the surface thereof and then forming an aggregate having a meso-macro hierarchical pore structure due to agglomeration of the carbon nanoparticles. The number of active sites in the aggregate is increased due to nitrogen doping.

In the present invention, the nitrogen-containing carbon precursor is heterocyclic amine having nitrogen atoms.

In the present invention, the heterocyclic amine is one or more selected from the group consisting of pyridine, quinoline, isoquinoline, pyrrole, pyrrolidine, piperidine, indole, imidazole, pyrimidine, and melamine.

In the present invention, the carbon nanoparticles have a BET specific surface area of 200 to 400 m²/g.

In order to accomplish another object, the present invention provides a nitrogen-carbon aggregate manufactured using the above method.

In order to accomplish yet another object, the present invention provides a sodium ion battery which includes an electrode including the nitrogen-carbon aggregate, and an electrolyte receiving the electrode therein and including sodium ions as a delivery carrier.

According to a method of manufacturing a nitrogen-carbon aggregate having a hierarchical pore structure, a nitrogen-carbon aggregate manufactured therefrom, and a sodium ion battery including the same according to the present invention, there are the following effects.

First, plasma discharge is performed using only a nitrogen-containing carbon precursor solution without the use of separate additives, thus forming nitrogen-doped carbon nanoparticles having micropores in the surface thereof. By performing agglomeration of the nitrogen-doped carbon nanoparticles, it is possible to manufacture a nitrogen-carbon aggregate having a hierarchical pore structure of mesopores and macropores.

Second, the nitrogen-doped carbon nanoparticles that constitute the nitrogen-carbon aggregate are formed to have a nano size, thus shortening the diffusion path of sodium ions and ensuring a wide path caused by an internal turbostratic structure, whereby it is possible to ensure sufficient voids.

Third, since the number of active sites in the nitrogen-carbon aggregate is increased due to the extrinsic defects generated in carbon nanoparticles due to nitrogen doping, when the nitrogen-carbon aggregate is applied as the cathode active material of the sodium ion battery, sufficient contact force is provided at the interface between an electrode and an electrolyte, thus facilitating the internal diffusion of sodium ions, whereby it is possible to ensure excellent discharge capacity.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a flowchart showing a process according to a method of manufacturing a nitrogen-carbon aggregate of the present invention;

FIG. 2 is a mimetic diagram showing plasma discharge for manufacturing a nitrogen-carbon aggregate according to the present invention;

FIG. 3 is a mimetic diagram showing the nitrogen-carbon aggregate manufactured according to the present invention;

FIG. 4 is a photograph showing the nitrogen-carbon aggregate according to the present invention, in which FIGS. 4A, 4B, and 4C show a transmission electron micrograph (TEM, JEM-2100F) of the nitrogen-carbon aggregate, FIG. 4D shows a high-resolution TEM (HR-TEM, JEM-2100F) of the nitrogen-doped carbon nanoparticles, and FIG. 4E shows elemental mapping performed using an energy dispersive X-ray spectroscope (EDS) attached to a TEM device;

FIG. 5A is a graph showing the nitrogen adsorption and desorption isotherm of nitrogen-doped carbon nanoparticles using pyridine, and FIG. 5B is a graph showing the micropore size distribution of nitrogen-doped carbon nanoparticles using pyridine;

FIG. 6A is a graph showing the nitrogen adsorption and desorption isotherm of nitrogen-doped carbon nanoparticles using pyrrole, and FIG. 6B is a graph showing the micropore size distribution of nitrogen-doped carbon nanoparticles using pyrrole;

FIG. 7A is a graph showing the nitrogen adsorption and desorption isotherm of carbon black using benzene, and FIG. 7B is a graph showing the micropore size distribution of carbon black using benzene;

FIG. 8A is a graph showing the XPS spectrum of nitrogen-doped carbon nanoparticles, and FIG. 8B is a graph showing the N1 HR-XPS spectrum of nitrogen-doped carbon nanoparticles;

FIG. 9A is a graph showing the CV curve of the three initial cycle periods at a scan rate of 0.2 mV/s in a potential range of 0.01 to 3.0 V, and FIG. 9B is a graph showing the initial charging and discharging profiles of a nitrogen-carbon aggregate at a current density of 1 A/g;

FIG. 10A is a graph showing CV curves according to 0.01 to 3.0 V at different scan rates, FIG. 10B is a graph showing the linear relationship between the logarithm of a peak current and the logarithm of a scan rate, FIG. 10C is a graph showing the capacitive contribution ratio to the total capacity according to the scan rate, and FIG. 10D is a graph showing the relationship between the CV curve and the capacitive contribution at a scan rate of 0.7 mV/s; and

FIG. 11A is a graph showing the speed performance according to a current density, FIG. 11B is a graph showing the comparison of the speed performances between a conventional nitrogen-doped carbon and nitrogen-doped carbon nanoparticles of the present invention, and FIG. 11C is a graph showing the cycling performance at a current density of 100 mAh/g.

### DETAILED DESCRIPTION OF THE INVENTION

Hereinafter, the present invention will be described in detail.

The macropores described in the present specification mean pores having an average diameter of more than 50 nm, the mesopores mean pores having an average diameter of 2 to 50 nm, and the micropores mean pores having an average diameter of less than 2 nm.

Further, the turbostratic structure described in the present specification means a structure in which a crystalline domain does not have regularity but exhibits a slightly disordered three-dimensional orientation.

Further, each of the extrinsic defects described in the present specification mean a crystalline domain that does not form a complete lattice due to atomic doping.

Further, the active sites described in the present specification mean spaces in which atomic ions are adsorbed in application to a cathode active material of a battery.

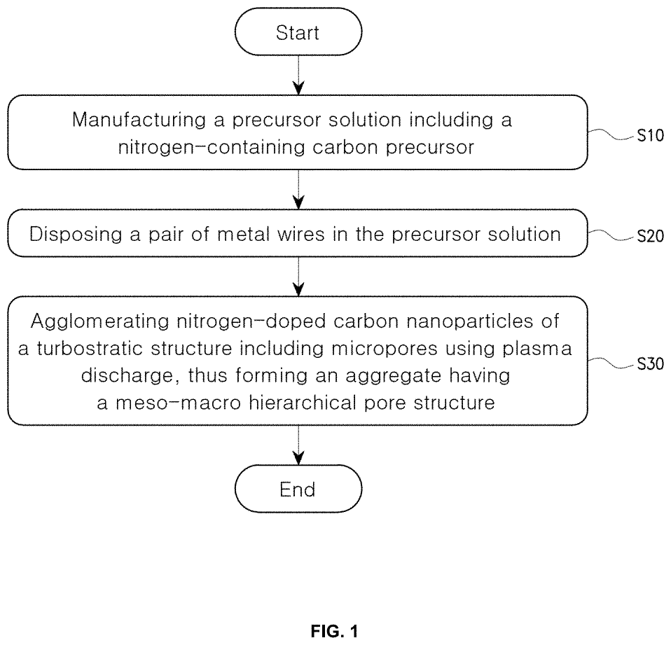

An aspect of the present invention relates to a method of manufacturing a nitrogen-carbon aggregate having a hierarchical pore structure. FIG. 1 is a flowchart showing a process according to the method of manufacturing the nitrogen-carbon aggregate of the present invention. Referring to FIG. 1, the method of manufacturing the nitrogen-carbon aggregate of the present invention includes a first step of manufacturing a precursor solution including a nitrogen-containing carbon precursor at step S10, a second step of disposing a pair of metal wires in the precursor solution at step S20, and a third step of applying electric power to the metal wires to discharge a plasma, so that nitrogen is bonded to carbon of the carbon precursor, thus forming nitrogen-doped carbon nanoparticles of a turbostratic structure including micropores in the surface thereof and then forming an aggregate having a meso-macro hierarchical pore structure due to agglomeration of the carbon nanoparticles at step S30. Accordingly, it is possible to manufacture a nitrogen-carbon aggregate in which a wide path is formed due to the turbostratic structure in the nitrogen-doped carbon nanoparticles to thus ensure sufficient voids. In the nitrogen-carbon aggregate, the number of active sites in the nitrogen-carbon aggregate is increased due to the extrinsic defects generated on the carbon nanoparticles due to nitrogen doping.

According to the method of manufacturing the nitrogen-carbon aggregate of the present invention, the first step is a step of manufacturing a precursor solution that includes a nitrogen-containing carbon precursor at step S10.

That is, the carbon precursor containing nitrogen atoms is prepared in a liquid phase. The solution serves to synthesize the nitrogen-doped carbon nanoparticles while carbon synthesis and nitrogen doping are performed in situ in the subsequent third step, and also to synthesize the nitrogen-carbon aggregate in which the nitrogen-doped carbon nanoparticles are agglomerated.

It is preferable that the nitrogen-containing carbon precursor be heterocyclic amine having nitrogen atoms. The heterocyclic amine is a compound in which the nitrogen atom occupies a part of a ring, and enables nitrogen to be doped into the carbon nanoparticles while the carbon nanoparticles are synthesized. The heterocyclic amine may be classified as follows depending on the number of nitrogen atoms occupying the ring.

The heterocyclic amine including one nitrogen atom may be one or more selected from the group consisting of pyridine, pyridine homologues, pyridine isomers, isomers of pyridine homologues, quinoline, isoquinoline, acridine, pyrrole, pyrrolidine, piperidine, and indole. The heterocyclic amine including two nitrogen atoms may be one or more selected from the group consisting of imidazole and pyrimidine. The heterocyclic amine including three nitrogen atoms may be melamine.

However, the heterocyclic amine is not limited to the above-mentioned types, and any one having one to three nitrogen atoms in the ring may be used in various ways. In some cases, when solid heterocyclic amine is used, the solid heterocyclic amine may be dissolved in the liquid heterocyclic amine and used in that state.

Next, the second step is a step of disposing a pair of metal wires in the precursor solution at step S20.

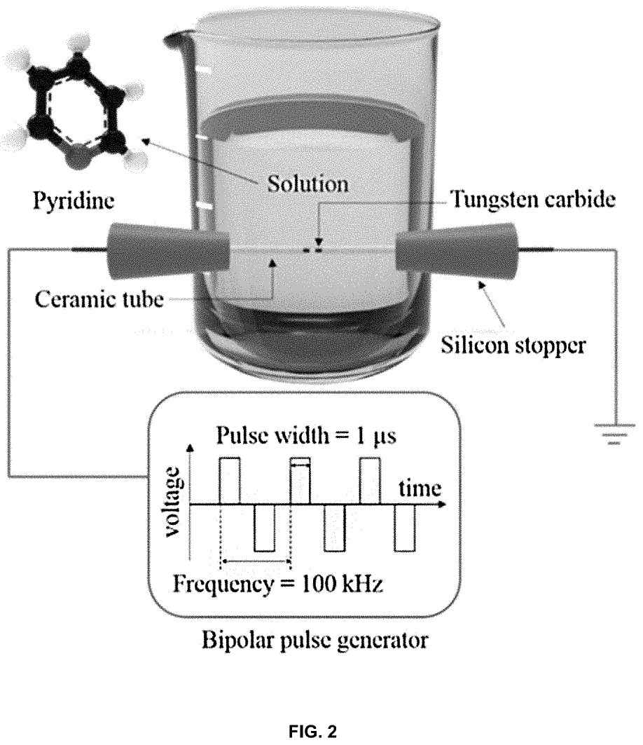

As shown in FIG. 2, in order to form the nitrogen-doped carbon nanoparticles and the nitrogen-carbon aggregate using liquid-phase plasma discharge (solution plasma process, SPP), a chamber, a pair of tungsten carbides which are electrodes located in the chamber, a ceramic tube surrounding the tungsten carbides so as to protect the tungsten carbides, and an electric power unit (not shown) that applies electric power to the electrodes are prepared.

That is, the chamber has a space in which the nitrogen-containing carbon precursor is received, and provides a space in which liquid-phase plasma discharge occurs. The electrodes are longitudinally disposed in a row to face each other in the chamber in order to cause plasma discharge in the solution, thus forming the nitrogen-doped carbon nanoparticles and the nitrogen-carbon aggregate. However, the electrodes may be interpreted to have the same sense as the metal wires.

Lastly, the third step is a step of applying electric power to the metal wires to discharge a plasma, so that nitrogen is bonded to carbon of the carbon precursor, thus forming nitrogen-doped carbon nanoparticles of a turbostratic structure including micropores in the surface thereof and then forming an aggregate having a meso-macro hierarchical pore structure due to agglomeration of the carbon nanoparticles at step S30.

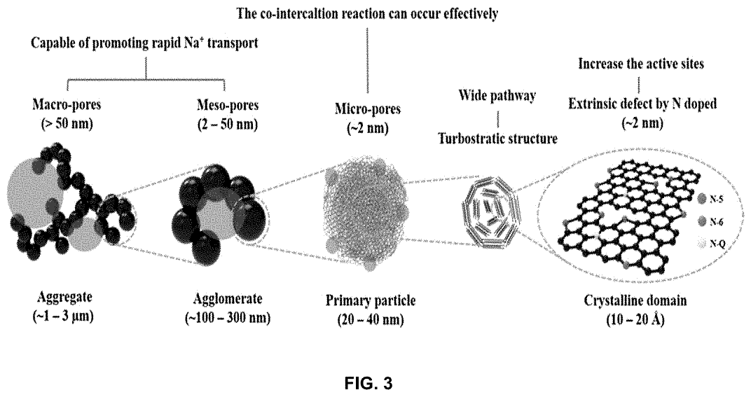

The aggregate is a nitrogen-carbon aggregate formed due to agglomeration of the nitrogen-doped carbon nanoparticles having micropores in the surface thereof while nitrogen is bonded to carbon. The nitrogen-carbon aggregate manufactured according to the present invention is confirmed from the mimetic diagram shown in FIG. 3.

The pore structure is important for the movement and diffusion of sodium ions. The macropores, the mesopores, the micropores, and the nitrogen-carbon aggregate having the turbostratic structure shown in FIG. 3 are synthesized using the plasma discharging shown in FIG. 2.

The plasma discharging is performed by applying bipolar-pulsed-direct-current power so that a pulse width is 0.1 to 3 μs, a frequency is 80 to 150 kHz, and a voltage is 1.0 to 5.0 kV.

When the pulse width is less than 0.1 μs, nitrogen is not sufficiently doped into the carbon nanoparticles. When the pulse width is more than 3 μs, carbon synthesis and nitrogen doping reactions may be excessive, which may be an obstacle to increasing the number of active sites. Accordingly, the pulse width is preferably 0.1 to 3 μs, and most preferably 1 μs.

When the frequency is less than 80 kHz, a phenomenon whereby the plasma is deactivated occurs, and when the frequency is more than 150 kHz, the plasma may be transformed into arc plasma. For this reason, the frequency is preferably in the range of 80 to 150 kHz, and is most preferably 100 kHz.

When the voltage is less than 1.0 kV, there is a possibility that the plasma may be deactivated in the process of discharging the plasma due to the insufficient voltage. When the voltage is more than 5.0 kV, the plasma is transformed into arc plasma, which makes it difficult to form the nitrogen-doped carbon nanoparticles and which interrupts agglomeration of the nitrogen-doped carbon nanoparticles. Accordingly, the voltage is preferably 1.0 to 5.0 kV, and most preferably 1.2 kV.

The nitrogen-containing carbon precursor solution is subjected to plasma discharging, thus forming the nitrogen-doped carbon nanoparticles having a size of 20 to 40 nm, and the nitrogen-doped carbon nanoparticles are agglomerated with each other to thus form a hierarchical pore structure.

When the size of the nitrogen-doped carbon nanoparticles is smaller than 20 nm, it is difficult to create a satisfactory meso-macro hierarchical pore structure. When the size of the nitrogen-doped carbon nanoparticles is larger than 40 nm, since insufficient space may be formed between the turbostratic structures, it may be difficult to diffuse sodium ions, or in contrast, a very large space may be formed between the turbostratic structures, causing breakage of the nitrogen-doped carbon nanoparticles. Therefore, it is preferable to form the nitrogen-doped carbon nanoparticles having a size of 20 to 40 nm, thereby shortening the path through which sodium ions are diffused in the nitrogen-carbon aggregate, so that the diffusion of the nanoparticles into the interior of the nitrogen-carbon aggregate can be achieved quickly.

The nitrogen-doped carbon nanoparticles may have a BET specific surface area of 200 to 400 m²/g. When the BET specific surface area of the nitrogen-doped carbon nanoparticles is smaller than 200 m²/g, sufficient contact force is not realized at the interface between the electrode and the electrolyte, which hinders the movement of sodium ions. On the other hand, when the BET specific surface area of the nitrogen-doped carbon nanoparticles is larger than 400 m²/g, sufficient contact may be ensured at the interface between the electrode and the electrolyte, but side reactions are caused by the very large BET specific surface area, resulting in rapid reduction of initial coulombic efficiency. Accordingly, there is a drawback in that the lifespan thereof is reduced. Therefore, it is preferable that the nitrogen-doped carbon nanoparticles have a BET specific surface area of 200 to 400 m²/g. The BET specific surface area is obtained by analyzing data on the amount of adsorption relative to the relative pressure according to an argon gas adsorption method (argon gas isothermal adsorption and desorption curve) using a BET equation.

In particular, the turbostratic structure of nitrogen-doped carbon nanoparticles includes a plurality of crystalline domains, thus forming a wide path for the creation of voids. This is advantageous from the aspect of diffusion of sodium ions. Further, when nitrogen is doped into the carbon nanoparticles, the extrinsic defects caused by the nitrogen atoms create a space having a size of 10 to 20 Å in the crystalline domain, thereby increasing the number of active sites in the nitrogen-carbon aggregate, making the diffusion of sodium ions easier.

Therefore, through the third step, it is possible to manufacture the nitrogen-carbon aggregate having the hierarchical pore structure which has a large specific surface area so that the sodium ions moved to the interface between the electrode and the electrolyte easily access the inside of a cathode active material. Through the hierarchical pore structure, the nitrogen-doped carbon nanoparticles, having micropores that allow a co-intercalation reaction of the sodium ions with the ether-based electrolyte on the surface thereof, and the sodium ions in the electrolyte are rapidly moved to the electrode interface.

That is, the nitrogen-doped carbon nanoparticles may have a nano size so that the sodium ions inserted into the cathode active material diffuse over a short distance, thus increasing the number of active sites due to the extrinsic defects caused by nitrogen used in doping, thereby manufacturing a nitrogen-carbon aggregate having a high discharge capacity.

As such, in the nitrogen-carbon aggregate, the micropores, the mesopores, and the macropores are three-dimensionally connected to each other, thus forming the nitrogen-doped carbon nanoparticles in a three-dimensional network. The micropores allow the co-intercalation reaction of the sodium ions with the ether-based electrolyte, and serve to create the transportation pathway of the sodium ions. The macropores have an ion buffer function that reduces the diffusion distance of the sodium ions, thereby ensuring the synergistic effect of electrochemical properties.

According to the above-described manufacturing method, in the present invention, after a pair of metal wires is disposed in the precursor solution including the nitrogen-containing carbon precursor, electric power is applied to the metal wires to discharge plasma, so that nitrogen is bonded to carbon, thus forming the nitrogen-doped carbon nanoparticles having the turbostratic structure including the micropores and then forming the aggregate having the meso-macro hierarchical pore structure due to agglomeration of the carbon nanoparticles. The number of active sites in the aggregate may be increased due to nitrogen doping.

In particular, the nitrogen-carbon aggregate is in a carbon black form in which nitrogen-doped carbon nanoparticles having a size of 20 to 40 nm are agglomerated, and has a hierarchical pore structure of mesopores and macropores. Accordingly, the nitrogen-doped carbon nanoparticles not only shorten the diffusion path of the sodium ions, but also facilitate the diffusion of the sodium ions due to the wide path caused by the turbostratic structure in the nitrogen-doped carbon nanoparticles. Further, the large specific surface area of the nitrogen-doped carbon nanoparticles and the extrinsic defects generated due to nitrogen doping may increase the number of active sites in the nitrogen-carbon aggregate, making the diffusion of sodium ions easier, thereby ensuring excellent discharge capacity.

In another aspect, the present invention relates to a nitrogen-carbon aggregate having a hierarchical pore structure, and the nitrogen-carbon aggregate may be manufactured using the above-mentioned method. That is, the present invention relates to an aggregate having a meso-macro hierarchical pore structure caused by agglomeration of carbon nanoparticles after nitrogen is bonded to carbon using plasma discharge in a precursor solution including a nitrogen-containing carbon precursor to thus form nitrogen-doped carbon nanoparticles of a turbostratic structure including micropores. The number of active sites thereof is increased due to nitrogen doping.

The nitrogen-carbon aggregate is formed in a three-dimensional network due to the agglomeration of the nitrogen-doped carbon nanoparticles. A plurality of macropores having an average pore diameter of more than 50 nm and a plurality of mesopores, which have an average pore diameter of 2 to 50 nm and are located adjacent to the macropores, form a hierarchical pore structure, and micropores are formed in the surfaces of the nitrogen-doped carbon nanoparticles.

That is, the macropores, the mesopores, and the micropores are three-dimensionally connected to each other, thus forming the nitrogen-carbon aggregate in the form of carbon black. In particular, the nitrogen-doped carbon nanoparticles constituting the nitrogen-carbon aggregate form a turbostratic structure including crystalline domains having a plurality of spaces each having a size of 10 to 20 Å.

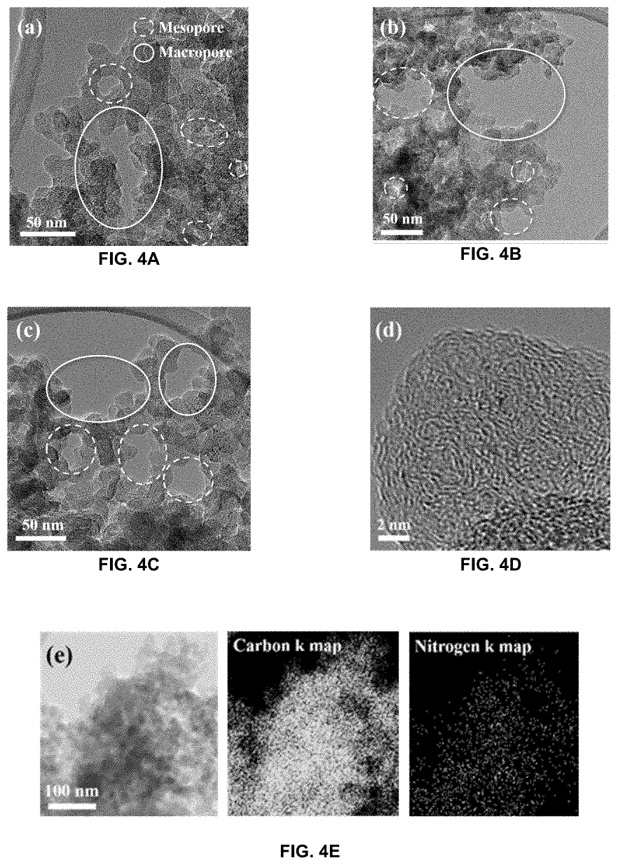

In this regard, as confirmed in FIG. 4, showing a photograph of the nitrogen-carbon aggregate according to the present invention, the nitrogen-doped carbon nanoparticles having a spherical shape are agglomerated to thus form the hierarchical pore structure of the nitrogen-carbon aggregate.

Referring to FIGS. 4A, 4B, and 4C, showing a transmission electron micrograph (TEM, JEM-2100F) of the nitrogen-carbon aggregate, it can be confirmed that nitrogen-doped carbon nanoparticles having a diameter of about 20 to 40 nm are agglomerated to form a uniform ball, and that each of the nitrogen-doped carbon nanoparticles has a carbon black form in which the particles are connected to each other in a chain-agglomeration state due to DLA (diffusion-limited aggregation), rather than plate-like graphene.

Further, it can be confirmed that the carbon nanoparticles that are agglomerated form mesopores and macropores to thus form a meso-macro hierarchical pore structure. This hierarchical pore structure may facilitate the movement of sodium ions from the bulk region of the electrolyte to the surfaces of the nitrogen-doped carbon nanoparticles, thereby maximizing the discharge capacity of a sodium ion battery.

FIG. 4D shows a high-resolution TEM (HR-TEM, JEM-2100F) of the nitrogen-doped carbon nanoparticles, in which it can be confirmed that a turbostratic structure having a relatively low annealing temperature is formed therein. Many voids are formed due to the turbostratic structure, thereby improving the capacity to adsorb and store sodium ions.

Further, FIG. 4E shows elemental mapping performed using an energy dispersive X-ray spectroscope (EDS) attached to a TEM device in order to investigate the nitrogen distribution in the nitrogen-doped carbon nanoparticles that are synthesized. As shown in FIG. 4E, it can be confirmed that nitrogen is uniformly distributed in the carbon nanoparticles.

In another aspect, the present invention relates to a sodium ion battery including a nitrogen-carbon aggregate having a hierarchical pore structure. The sodium ion battery includes an anode, a cathode including a current collector on which a nitrogen-carbon aggregate having a hierarchical pore structure is applied, and an ether-based electrolyte.

The sodium ion battery includes an anode containing an anode active material for storing sodium ions during discharge, a cathode containing a cathode active material for storing the sodium ions during charging, a separation membrane for delivering the sodium ions between the anode and the cathode, and an electrolyte acting as a delivery carrier of the sodium ions to the anode and the cathode.

Preferably, the cathode, the anode, and the separation membrane constitute an electrode assembly, and the electrode assembly and the electrolyte are housed in an exterior case to form the sodium ion battery. The cathode includes the current collector and a slurry applied on the surface of the current collector. The slurry may include the nitrogen-carbon aggregate according to the present invention, a conductive material, a polymer, and other additives mixed with each other therein.

For reference, as the current collector, a copper foil, a nickel foil, a stainless steel foil, a titanium foil, a nickel foam, a copper foam, a polymer substrate coated with a conductive metal, or combinations thereof may be used.

Hereinafter, Examples of the present invention will be described below in more detail. However, the following Examples are only illustrative to help understanding of the present invention, and the scope of the present invention is not limited thereby.

### <Example 1> Manufacture of Nitrogen-Carbon Aggregate Using Pyridine

A pyridine solution was used as a precursor solution including a nitrogen-containing carbon precursor, and a nitrogen-carbon aggregate was synthesized through plasma discharge in the solution in an ambient atmosphere at room temperature for 20 minutes (see FIGS. 2 and 3).

A pulse width was set to 1 μs, a frequency was set to 100 kHz, and a bipolar high-voltage pulse of 1.2 kV was applied to a pair of tungsten carbide electrodes using a PeKuris MPP-HV04 high-voltage bipolar pulse generator.

The synthesized nitrogen-carbon aggregate was divided into particles using a filter paper and then dried at 90° C. for 12 hours. Thereafter, the dried particles were evenly ground and then heat-treated in a quartz tube furnace in a nitrogen atmosphere at 500° C. for 3 hours at a heating rate of 10° C./min.

### <Example 2> Manufacture of Nitrogen-Carbon Aggregate Using Pyrrole

A pyrrole solution was used as a precursor solution including a nitrogen-containing carbon precursor, and a nitrogen-carbon aggregate was synthesized through plasma discharge in the solution in an ambient atmosphere at room temperature for 20 minutes.

A pulse width was set to 1 μs, a frequency was set to 100 kHz, and a bipolar high-voltage pulse of 1.2 kV was applied to a pair of tungsten carbide electrodes using a PeKuris MPP-HV04 high-voltage bipolar pulse generator.

The synthesized nitrogen-carbon aggregate was divided into particles using a filter paper and then dried at 90° C. for 12 hours. Thereafter, the dried particles were evenly ground and then heat-treated in a quartz tube furnace in a nitrogen atmosphere at 500° C. for 3 hours at a heating rate of 10° C./min.

### <Comparative Example 1> Manufacture of Carbon Black Using Benzene

A benzene solution was used as a precursor solution including a carbon precursor that did not contain nitrogen, and a carbon black was synthesized through plasma discharge in the solution in an ambient atmosphere at room temperature for 20 minutes.

A pulse width was set to 1 μs, a frequency was set to 100 kHz, and a bipolar high-voltage pulse of 1.2 kV was applied to a pair of tungsten carbide electrodes using a PeKuris MPP-HV04 high-voltage bipolar pulse generator.

Synthesized carbon black was divided into particles using filter paper and then dried at 90° C. for 12 hours. Thereafter, the dried particles were evenly ground and then heat-treated in a quartz tube furnace in a nitrogen atmosphere at 500° C. for 3 hours at a heating rate of 10° C./min.

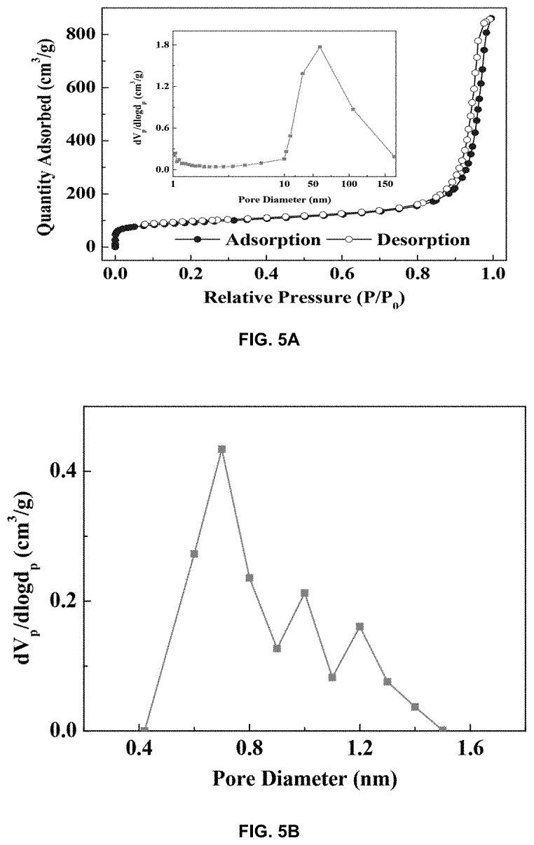

The nitrogen adsorption and desorption isotherm and the pore distribution of the nitrogen-carbon aggregates manufactured according to Examples 1 and 2 and the carbon black manufactured according to Comparative Example 1 were measured, and the results are shown in FIGS. 5 to 7.

The nitrogen adsorption and desorption isotherm was measured at 77K using an N2 adsorption analyzer (MicrotracBEL Corp., Belsorp-max), and each sample was degassed at 300° C. for 2 hours before measurement. The specific surface area was calculated using a Brunauer-Emmett-Teller (BET) method, and the pore distribution was obtained from the adsorption curve of the isotherm using a Barrett-Joyner-Halenda (BJH) method.

FIG. 5A is a graph showing the nitrogen adsorption and desorption isotherm of the nitrogen-doped carbon nanoparticles using pyridine. Referring to FIG. 5A, the pore structure of the nitrogen-doped carbon nanoparticles can be confirmed from the nitrogen adsorption and desorption isotherm. Further, from the adsorption curve of FIG. 5A, it is confirmed that a hysteresis loop indicating the presence of the mesopores and a continuous pore distribution in the range of 10 to 150 nm were obtained. For reference, the total pore volume of the nitrogen-doped carbon nanoparticles is 1.2975 cm³/g, the volume of mesopores is 0.6057 cm³/g, the volume of macropores is 0.6659 cm³/g, and the average pore diameter is 15.77 nm.

FIG. 5B is a graph showing the micropore size distribution of the nitrogen-doped carbon nanoparticles using pyridine. Referring to FIG. 5B, the presence of extrinsic defects and micropores in the nitrogen-doped carbon nanoparticles is confirmed from the narrow distribution at 0.5 to 0.8 nm.

Further, it can be seen that the specific surface area of the nitrogen-doped carbon nanoparticles calculated using the BET method is 265.15 m²/g, and that the large specific surface area of the nitrogen-doped carbon nanoparticles provides sufficient contact at the interface between the electrode and the electrolyte for the purpose of accumulating sodium ions or charges. As such, the large specific surface area of the carbon nanoparticles serves to increase the area of the electrolyte that is in contact with the electrode, thereby increasing the access of sodium ions to the interface.

Accordingly, it is confirmed that the large specific surface area of the carbon nanoparticles serves to improve the accessibility of the sodium ion, and that the sodium ions easily move in and out of the micropores formed in the surface of the carbon nanoparticles in a solvated state.

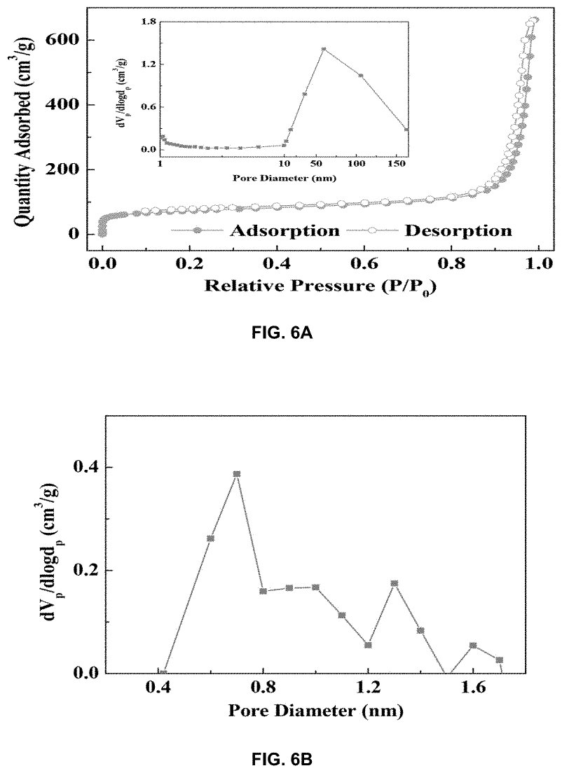

FIG. 6A is a graph showing the nitrogen adsorption and desorption isotherm of the nitrogen-doped carbon nanoparticles using pyrrole. Referring to FIG. 6A, the pore structure of the nitrogen-doped carbon nanoparticles can be confirmed from the nitrogen adsorption and desorption isotherm. As in FIG. 5A, the adsorption curve show the hysteresis loop indicating the presence of mesopores and the formation of the continuous pore distribution at 10 to 150 nm.

FIG. 6B is a graph showing the micropore size distribution of the nitrogen-doped carbon nanoparticles using pyrrole. As shown in FIG. 5B, the presence of the extrinsic defects and the micropores in the nitrogen-doped carbon nanoparticles is confirmed from the narrow distribution at 0.5 to 0.8 nm.

Further, the specific surface area of the nitrogen-doped carbon nanoparticles calculated using the BET method is 260.84 m²/g, which has a value similar to the specific surface area according to Example 1. This shows that it is possible to provide sufficient contact at the interface between the electrode and the electrolyte for the purpose of accumulating sodium ions or charges to thus increase the area of the electrolyte that is in contact with the electrode, thereby increasing the access of sodium ions to the interface.

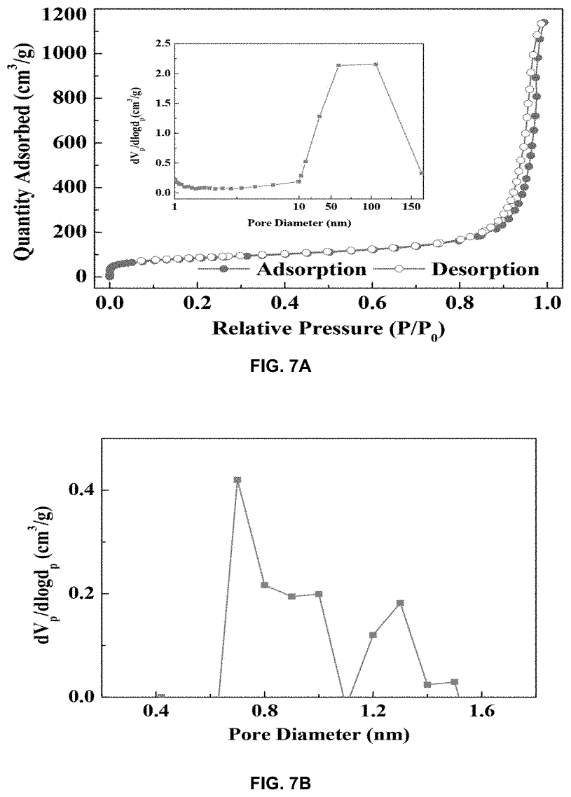

FIG. 7A is a graph showing the nitrogen adsorption and desorption isotherm of carbon black using benzene. It can be seen that the pore distribution at 10 to 150 nm of FIG. 7A is different from that of FIGS. 5A and 6A.

FIG. 7B is a graph showing the micropore size distribution of carbon black using benzene. Referring to FIG. 7B, it can be seen that the extrinsic defects and the micropores of FIG. 7B do not exist, similarly to the cases of FIGS. 5B and 6B.

Further, the specific surface area of the carbon black calculated using the BET method is 243.15 m²/g, which has a value relatively smaller than the specific surface areas according to Examples 1 and 2. This shows that sufficient contact force is not provided at the interface between the electrode and the electrolyte, which is disadvantageous for the movement of sodium ions.

In summary, from FIG. 7 according to Comparative Example 1, in the carbon black manufactured by plasma discharge using the benzene solution, the hierarchical pore structure of the mesopores and the macropores is partially confirmed, but it is also confirmed that the micropores are not uniformly formed. Unlike this, from FIGS. 5 and 6 according to Examples 1 and 2, in the case of the nitrogen-carbon aggregate manufactured by plasma discharge using the pyridine solution or the pyrrole solution, both the hierarchical pore structure of the mesopores and the macropores and the micropores formed in the surfaces of the nitrogen-doped carbon nanoparticles are confirmed.

### Experimental Example 1

In the present Experimental Example, the electrochemical properties of the nitrogen-carbon aggregate including the nitrogen-doped carbon nanoparticles were tested. The electrochemical characteristics were tested using coin-type half-cells (CR2032, Wellcos Corp.). A galvanostatic charge-discharge test was performed in a voltage range of 0.01 to 3.0 V (vs. Na/Na⁺) using a BCS-805 biologic battery test system. A CV (cyclic voltammetry) test was performed using the same device, and an EIS (electrochemical impedance spectroscopy) test was performed in the frequency range of 100 kHz to 0.01 Hz using the same device.

Preparation of Battery Sample

70 wt % of an active material including the nitrogen-carbon aggregate according to the present invention, 10 wt % of a conductive carbon black, and 20 wt % of a polyacrylic acid were mixed with each other and then dissolved in distilled water to manufacture a slurry as a working electrode. The slurry thus manufactured was uniformly applied on a copper foil (Cu foil) using a doctor blade and dried in a vacuum-drying oven at 80° C. for 12 hours. Then, the resultant foil was compressed to a thickness of 35 μm using a roll press and then punched into a coin shape using a punching tool. The weight of the sample was measured three to four times using an electronic analytical balance, and the value thereof was approximately 1.8 mg/cm.

For a counter electrode, coin cells were assembled in an Ar-filled glove box using sodium metal. A glass fiber filter was used as a separation membrane, and 1M NaPF₆ in diethylene glycol dimethyl ether (DEGDME) was used as an electrolyte.

Elementary Analysis

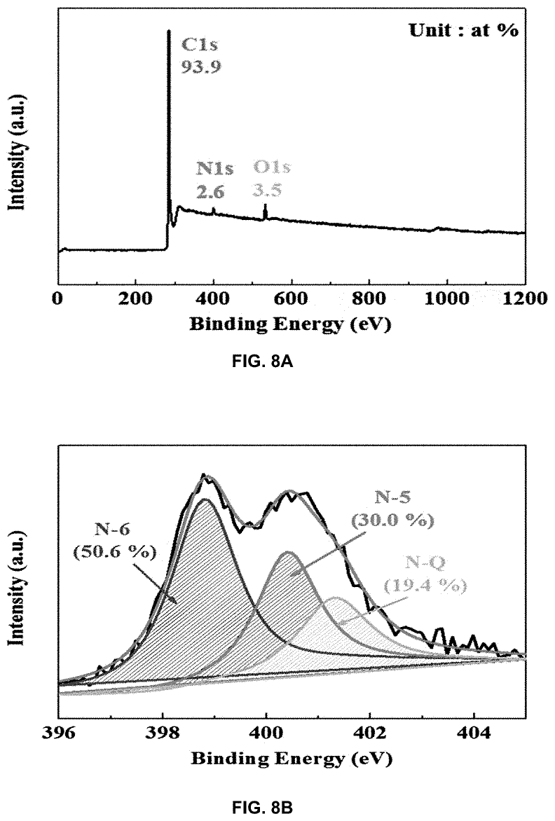

XPS and HR-XPS measurements were performed in order to investigate the surface composition and the bonding state of the nitrogen-doped carbon nanoparticles, which are shown in FIGS. 8A and 8B.

FIG. 8A is a graph showing the XPS spectrum of the nitrogen-doped carbon nanoparticles according to the present invention. Referring to FIG. 8A, peaks corresponding to C1, N1, and O1 are evident, and the constitution including 93.9 at % of C1, 2.6 at % of N1, and 3.5 at % of O1 is confirmed.

Since plasma discharge causes the generation of plasma in the nitrogen-containing precursor solution, extrinsic oxygen is completely blocked, so that the possibility of oxidation of nitrogen is fundamentally excluded due to the absence of oxygen in the nitrogen-containing carbon precursor solution. The O1 peak measured in FIG. 8A corresponds to oxygen adsorbed on the surface during the preparation and measurement of the sample.

FIG. 8B is a graph showing the N1 HR-XPS spectrum of the nitrogen-doped carbon nanoparticles according to the present invention. FIG. 8B shows that the N1 peak is divided into peaks indicating N-6 (pyridinic-N), N-5 (pyrrolic-N), and N-Q (graphitic) at 398.7 eV, 400.2 eV, and 401.2 eV.

In particular, from FIG. 8B, doping of nitrogen into the carbon nanoparticles is confirmed. Of the total nitrogen dopants, N-6 and N-5 account for high proportions of 50.6% and 30.0%, respectively, which plays an important role in determining reversible capacity. It can be seen that nitrogen atoms exist on an extrinsic defect portion or an edge portion instead of on a graphene surface. N-6 and N-5 may be bonded to the lattice of the extrinsic defect portion or the edge portion of the carbon nanoparticles, thus increasing the number of active sites to help the diffusion of sodium ions, thereby increasing the movement and storage capacity of the sodium ions. Further, the micropores formed in the surface of N-Q and carbon nanoparticles may induce a co-intercalation reaction between the sodium ions and the ether-based electrolyte, thus improving electrical conductivity.

Unlike the nitrogen-doped carbon nanoparticles shown in FIG. 8, in the case of the carbon black synthesized using the carbon precursor solution that does not contain nitrogen, since nitrogen is not doped into the carbon black, an empty space is not formed in the carbon lattice constituting the carbon black, so the active site that facilitates diffusion of the sodium ions is not formed.

Analysis of Charging and Discharging Characteristics

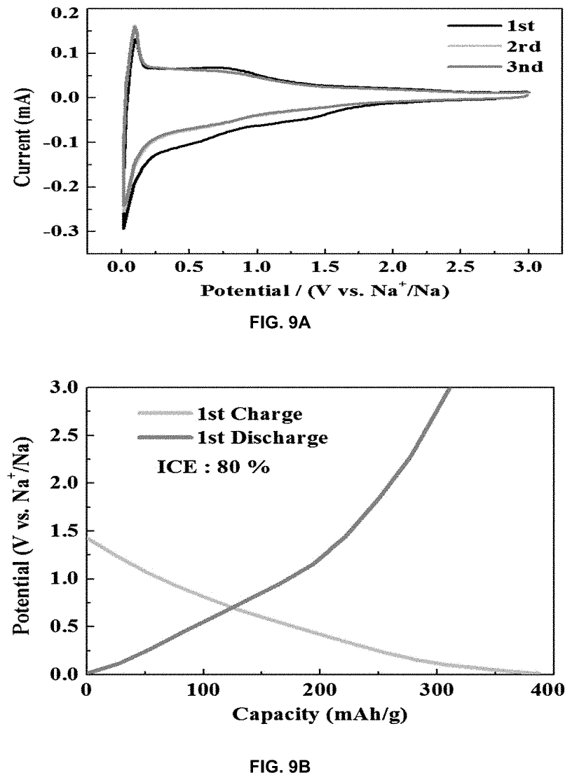

FIG. 9A is a graph showing the CV curve of the three initial cycle periods at a scan rate of 0.2 mV/s in a potential range of 0.01 to 3.0 V.

In a reduction process, there is no clear peak indicating electrolytic decomposition between a first cycle (1st) and a second cycle (2nd), meaning that some sodium ions are captured without forming a SEI (solid-electrolyte interphase) film. As the second cycle (2nd) and the third cycle (3rd) are formed to overlap each other, it can be seen that insertion, elimination, adsorption and desorption reactions of the sodium ions are stably performed.

In FIG. 9A, a pair of sharp redox peaks appearing in the low potential region (0.01 to 0.15 V) of a CV curve is caused by the co-insertion and extraction reaction of the sodium ions and an ether solvent and the reaction of molecules in a graphite structure. The broad peak of 0.14 to 3.0 V is caused by adsorption and desorption reactions in small graphite clusters.

FIG. 9B is a graph showing the initial charging and discharging profiles at a current density of 1 A/g. An initial coulombic efficiency reached 80% even though the specific surface area is large (328.93 m²/g). This is consistent with the result of the CV curve mentioned above, indicating that the specific surface area is not directly related to the initial coulombic efficiency.

The discharging profile may be divided into a small plateau region of less than 0.15 V and a sloping region of 0.15 V or more, which is consistent with the CV result mentioned above. The capacity of the plateau region and the capacity of the sloping region are 23 mAh/g and 264 mAh/g, respectively, which means that adsorption and desorption reactions are predominant in the storage of the sodium ions.

Analysis of Sodium Ion Storage Capacity

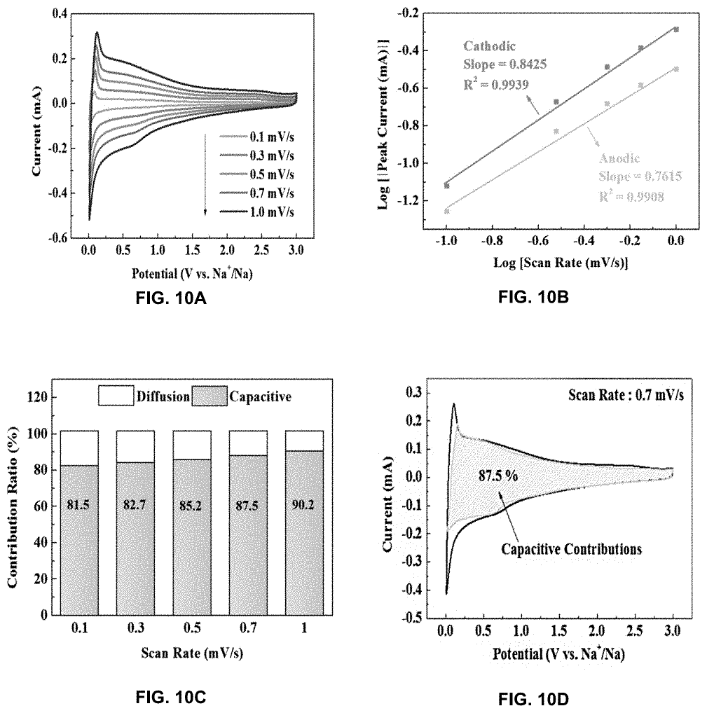

First, FIG. 10A is a graph showing CV curves for 0.01 to 3.0 V at different scan rates. The adsorption and desorption reactions may be calculated using the following Equation 1 with reference to FIG. 10A.

I=av^{b} [Equation 1]

A b value may be calculated from a CV curve at different scan rates, and the kinetics for storage of the sodium ions may be represented by the b value. It is assumed that the diffusion is dominant as the b value becomes close to 0.5 and that a b value approaching 1 indicates a capacity control reaction.

FIG. 10B is a graph showing a linear relationship between the logarithm of a peak current and the logarithm of a scan rate. According to FIG. 10B, the b value was found to be 0.7615 and 0.8425, which are close to 1, so it can be seen that the sodium ion storage mechanism is represented by a capacity control reaction favorable for the rapid kinetics of sodium. This means to be caused by adsorption on the abundant voids and active sites.

FIG. 10C is a graph showing the capacitive contribution ratio to the total capacity according to the scan rate. This is quantitatively evaluated by the following [Equation 2].

I(V)=k₁ᵥ+k₂ᵥ^{1/2} [Equation 2]

I(V) is a total current at a fixed potential (V), and k₁ᵥ and k₂ᵥ^{1/2} represent the diffusion and the capacitive contribution at the total sodium ion storage capacity, respectively.

As shown in FIG. 100, it can be seen that as the scan rate is increased from 0.1 mV/s to 1 mV/s, the capacitive contribution ratio is gradually increased from 81.5% to 90.2%. At a scan rate of 0.7 mV/s, the capacitive contribution to total capacity was found to be 87.5%.

FIG. 10D is a graph showing the relationship between the CV curve and the capacitive contribution at a scan rate of 0.7 mV/s. Referring to FIG. 10D, it can be seen that the capacitive contribution to the total capacity is 87.5% at a scan rate of 0.7 mV/s. This shows that the sodium ion storage capacity of the nitrogen-doped carbon nanoparticles is mostly based on a fast capacitive reaction.

In the high-capacity sodium ion storage mechanism, the action of the sodium ions on the SEI film formation reaction is reduced, resulting in high initial coulombic efficiency, which is consistent with the charge and discharge profiles. Further, the high capacitive contribution may improve the speed of the sodium ion battery.

Output Characteristic Analysis

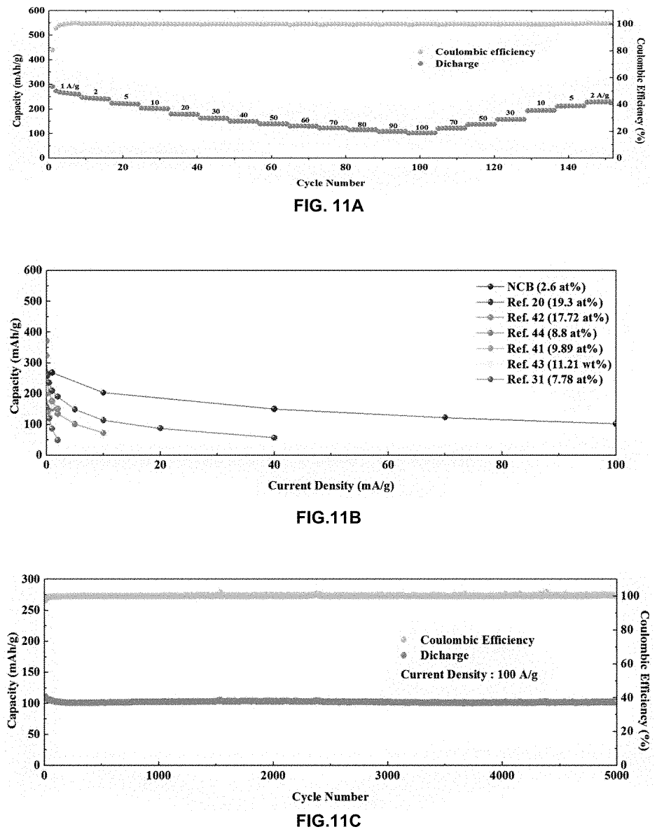

FIG. 11A is a graph showing the speed performance according to current density. As the current density is increased to 1, 2, 5, 10, 20, 30, 40, 50, 60, 70, 80, 90, and 100 A/g, the reversible capacity is changed to 265, 243, 221, 202, 178, 162, 150, 139, 122, 115, 108, and 102 mAh/g. When the current density is 100 A/g, the reversible capacity is 102 mAh/g.

Further, referring to FIG. 11A, it can be seen that the reversible capacity is fully recovered when the current density is reduced back to 1 A/g after cycling at 100 A/g. This result shows a high capacitive contribution caused by the extrinsic defects provided due to nitrogen doping, and is based on the phenomenon whereby the sodium ions are capable of being rapidly moved due to the meso-macro hierarchical pore structure.

FIG. 11B is a graph showing the comparison of the speed performances between a conventional nitrogen-doped carbon and nitrogen-doped carbon nanoparticles of the present invention. The reversible capacities of the nitrogen-doped carbon, which was commercially available and randomly obtained (Ref. 20, Ref. 42, Ref. 44, Ref. 41, Ref. 43, and Ref. 31), and the nitrogen-doped carbon nanoparticles according to the present invention, depending on the current density, were compared and are shown therein.

According to FIG. 11B, the conventional nitrogen-doped carbon may only increase the current density up to 40 mA/g. However, in the present invention, even when the current density is increased to 100 mA/g, sufficient reversible capacity is capable of being provided, so it can be confirmed that the speed performance is excellent.

In particular, referring to FIG. 11B, the conventional nitrogen-doped carbon was doped with nitrogen in an amount of 19.3 at %, 17.72 at %, 8.8 at %, 9.89 at %, 11.21 at %, and 7.78 at %, respectively. However, the nitrogen-doped carbon nanoparticles of the present invention were doped with nitrogen in an amount of 2.6 at %. Accordingly, it is confirmed that the speed performance is higher in the present invention than in the prior art even though nitrogen is doped in a relatively smaller amount in the present invention than in the prior art. For reference, at % represents the composition ratio in terms of the number of atoms, and the at % of doped nitrogen is calculated as (number of nitrogen atoms/number of atoms of nitrogen-doped carbon nanoparticles)×100.

FIG. 11C is a graph showing the cycling performance at a current density of 100 A/g. It can be confirmed that a reversible capacity of about 105 mAh/g is provided for 5,000 cycles at a current density of 100 A/g. This means that it leads to a rapid diffusion path for sodium ions due to the high capacitive contribution caused by the active sites and the formation of the nanostructure of the nitrogen-doped carbon nanoparticles.

As described above, the present invention relates to a method of manufacturing a nitrogen-carbon aggregate having a hierarchical pore structure, a nitrogen-carbon aggregate manufactured therefrom, and a sodium ion battery including the same. After a precursor solution including a nitrogen-containing carbon precursor is manufactured, a pair of metal wires is disposed in the precursor solution. Thereafter, electric power is applied to the metal wires to discharge a plasma, so that nitrogen is bonded to carbon of the carbon precursor, thus forming nitrogen-doped carbon nanoparticles of a turbostratic structure including micropores in the surface thereof and then forming an aggregate having a meso-macro hierarchical pore structure due to agglomeration of the carbon nanoparticles. The number of active sites of the aggregate may be increased due to nitrogen doping.

As such, the present invention has the following significant meaning. The nanostructure of the nitrogen-doped carbon nanoparticles is formed to thus shorten the diffusion path of the sodium ions, and voids are formed due to the internal turbostratic structure. Further, the number of active sites is increased due to extrinsic defects generated using nitrogen doping, so that sufficient contact force is provided at the interface between an electrode and an electrolyte, thus facilitating the movement of the sodium ions, which leads to easy internal diffusion.

Therefore, according to the present invention, it is possible to synthesize a nitrogen-carbon aggregate which has macropores, mesopores, and micropores, as well as a turbostratic structure, so that the number of active sites is increased due to extrinsic defects generated using nitrogen doping. Accordingly, electrical conductivity is improved and excellent discharge capacity is ensured. Therefore, the nitrogen-carbon aggregate is expected to be used in practice as a cathode active material for sodium ion batteries.

The above description is only to illustrate the technical idea of the present invention by way of example, and those of ordinary skill in the art to which the present invention pertains will appreciate that various modifications and variations are possible without departing from the essential characteristics of the present invention. Therefore, the embodiments disclosed in the present invention are not intended to limit the technical spirit of the present invention, but to explain the same, and the scope of the technical spirit of the present invention is not limited by these embodiments. The scope of protection of the present invention should be interpreted by the claims below, and all technical spirits within the scope equivalent thereto should be interpreted as being included in the scope of the present invention.

1. A method of manufacturing a nitrogen-carbon aggregate having a hierarchical pore structure, the method comprising:
a first step of manufacturing a precursor solution including a nitrogen-containing carbon precursor;
a second step of disposing a pair of metal wires in the precursor solution; and
a third step of applying electric power to the metal wires to discharge a plasma, so that nitrogen is bonded to carbon of the carbon precursor, thus forming nitrogen-doped carbon nanoparticles of a turbostratic structure including micropores in a surface thereof and then forming an aggregate having a meso-macro hierarchical pore structure due to agglomeration of the carbon nanoparticles,
wherein a number of active sites in the aggregate is increased due to nitrogen doping.

2. The method of claim 1, wherein the nitrogen-containing carbon precursor is heterocyclic amine having nitrogen atoms.

3. The method of claim 2, wherein the heterocyclic amine is at least one selected from the group consisting of pyridine, quinoline, isoquinoline, pyrrole, pyrrolidine, piperidine, indole, imidazole, pyrimidine, and melamine.

4. The method of claim 1, wherein the carbon nanoparticles have a BET specific surface area of 200 to 400 m2/g.

5. A nitrogen-carbon aggregate manufactured using the method of claim 1.

6. A sodium ion battery comprising:
an electrode including the nitrogen-carbon aggregate according to claim 5; and
an electrolyte receiving the electrode therein and including sodium ions as a delivery carrier.
